(19) United States
(12) Patent Application Publication
(10) Pub. No.: US 2014/0369547 A1
(43) Pub. Date: Dec. 18, 2014

(54) SUSPENSION MEMBER WITH INTEGRATED SEALING MEMBER

(71) Applicant: Gettop Europe R&D APS, Birkerod (DK)

(72) Inventor: Yao Qingshan, Skodsborg (DK)

(21) Appl. No.: 14/366,946

(22) PCT Filed: Dec. 21, 2012
(86) PCT No.: PCT/EP2012/076647

§ 371 Date: Jun. 19, 2014

Related U.S. Application Data
(60) Provisional application No. 61/581,512, filed on Dec. 29, 2011.

(51) Int. Cl. H04R 3/00

(52) U.S. Cl. CPC H04R 3/00; H04R 2207/00
USPC 381/398

(57) ABSTRACT

The present invention relates to a suspension member for suspending a moveable piston structure of a transducer, the suspension member comprising tolerance compensation means comprising an elastomeric material, said tolerance compensation means being formed as a structure extending in a direction so as to form an acoustical seal between a first chamber and a second chamber.

### FIELD OF THE INVENTION

The present invention relates to a suspension member for transducers, such as miniature loudspeakers. In particular, the present invention relates to elastomeric suspension members having sealing members attached thereto or integrated therewith.

### BACKGROUND OF THE INVENTION

It is well-known that during assembling of compact devices such as cell phones, tablets, game consoles, laptops etc. manufacturing and assembling tolerances must be considered to ensure proper acoustical performance of the final device. In particular, correct mounting of pre-manufactured miniature transducers, such as miniature loudspeakers, are essential for the overall acoustical performance of such compact devices.

Pre-manufactured miniature transducers are normally configured to be electrically connected to a supporting printed circuit board (PCB) using a spring-based connection arrangement. Alternatively, pre-manufactured miniature transducers may by configured as surface mount devices (SMDs), i.e. they are configured to be mounted directly on PCBs. Both types of transducers are adapted to be sandwiched between a PCB and a device cover during assembling of the device.

In order to perform in accordance with predetermined transducer specifications miniature transducers are typically sandwiched between a PCB and an inner surface of a device cover. However, the distance between the PCB and the inner surface of the cover typically varies from device to device due to manufacturing and assembling tolerances. If the distance falls within a lower end of a typical distance range an unnecessary mechanical stain is put onto the transducer. If the distance falls within an upper end of the typical distance range an acoustical leak may be formed between the transducer and the inner surface of the cover.

Thus, the varying distance between PCB and cover needs to be compensated for in order to ensure proper acoustical performance of the final device.

It may be seen as an object of embodiments of the present invention to provide suspension members having sealing members for compensating for manufacturing and/or assembling processes.

### DESCRIPTION OF THE INVENTION

The above-mentioned object is complied with by providing, in a first aspect, a suspension member for suspending a moveable piston structure of a transducer, the suspension member comprising tolerance compensation means comprising an elastomeric material, said tolerance compensation means being formed as a structure extending in a direction so as to form an acoustical seal between a first chamber and a second chamber.

The suspension member and the tolerance compensation means may form a one-piece structure.

Thus, the first aspect of the present invention relates to a suspension member for suspending a moveable piston structure in a transducer, such as a miniature loudspeaker suitable for applications in cell phones, tablets, portable game consoles, laptops and similar devices.

It is an advantage of the suspension member according to the present invention that it compensates for manufacturing and assembling tolerances whereby for example mechanical stain of the transducer and unwanted acoustical leaks can be avoided.

The suspension member may further comprise a piston region adapted to be attached to the moveable piston structure. The suspension member and the moveable piston structure attached thereto form a complete diaphragm in combination. The piston region may be attached to the moveable piston structure using a glue or a similar adhesive.

Moreover, a flexible member connecting the attachment region and the piston region may be provided as well.

The tolerance compensation means, attachment region, the piston region and the flexible member may form an integrated one-piece structure. Preferably, the tolerance compensation means, attachment region, the piston region and the flexible member form an integrated silicone one-piece structure, i.e. an integrated silicone-based suspension member.

The tolerance compensation means may be formed as a flexible extending structure in a direction so as to form an acoustical seal between a front chamber and a back chamber. The aim of the tolerance compensation means is to compensate for manufacturing and, in particular, assembling tolerances.

The tolerance compensation means is adapted to abut a planar structure, such as an inner surface of a cell phone cover, so as form the before-mentioned acoustical seal between the front chamber and the back chamber, wherein the front chamber may be defined as an acoustically sealed chamber defined by an upper surface of the piston structure, the suspension member, the tolerance compensation means and the planar structure in combination. The back chamber may be defined as an acoustical chamber being in acoustical communication with a lower surface of the piston structure.

In order to establish the acoustical seal the flexible extending structure may extend primarily in a direction being essentially parallel to the direction of movement of the moveable piston structure.

In a second aspect the present invention relates to a diaphragm comprising a suspension member according to the first aspect, said diaphragm further comprising a moveable piston structure attached to a piston region of said suspension member. The moveable piston structure may be in the form of a mica sheet, i.e. a sheet of silicate minerals.

In a third aspect the present invention relates to a transducer comprising a diaphragm according to the second aspect, said transducer further comprising a voice coil attached to a moveable piston structure, and drive means for moving the diaphragm in response to incoming electrical signals.

In a fourth and final aspect the present invention relates to a portable communication or gaming device comprising a transducer according to the third aspect.

### BRIEF DESCRIPTION OF THE DRAWINGS

The present invention will now be explained in further details with reference to the accompanying figures, wherein

FIG. 1 illustrates the problem of prior art systems,

FIG. 2 shows a cross-sectional view of a transducer comprising a suspension member having tolerance compensation means of a first type,

FIG. 3 shows a cross-sectional view of a transducer comprising a suspension member having tolerance compensation means of a second type, and

FIG. 4 shows a cross-sectional view of a transducer sandwiched between a PCB and a cover.

While the invention is susceptible to various modifications and alternative forms, specific embodiments have been disclosed by way of examples. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE DRAWINGS

In its most general aspect the present invention relates to a suspension member of an elastomeric material, such as silicone. The elastomeric properties of the elastomeric material are utilized for providing an arrangement for compensating for manufacturing and, in particular, assembling tolerances.

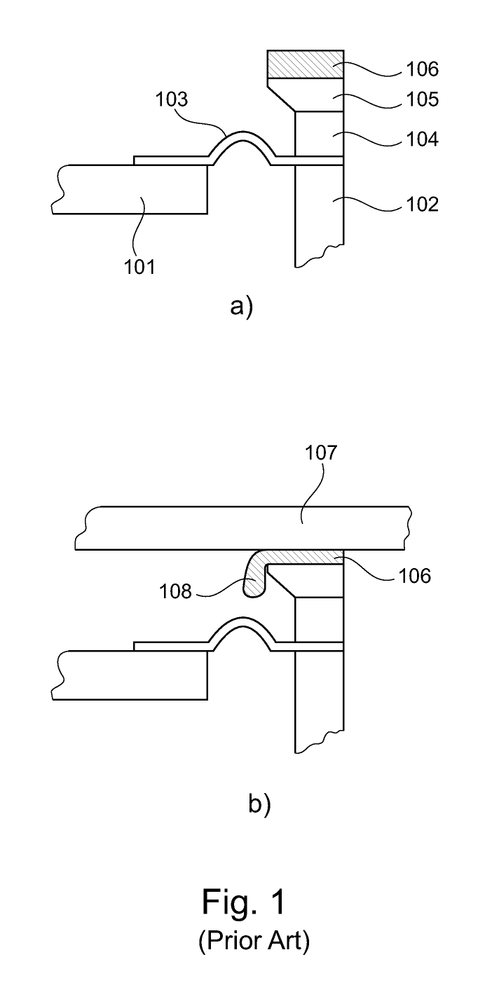

FIG. 1a shows a prior art arrangement including a piston 101 attached to a suspension member 103. The suspension member 103 is secured to a transducer frame 102 and a front frame typically being divided into a lower part 104 and an upper part 105. A foam layer 106 is arranged on top of the upper part 105 of the front frame. The foam 106, which is provided in a separate process step, is adapted to form an acoustic seal between the transducer and the cover of the device housing the transducer so as to avoid acoustic short circuiting of the transducer, i.e. avoid that air pushed by the piston 101 escapes to the back-side of the transducer. An effective acoustic seal ensures that acoustic short circuiting is prevented and that sound waves propagate in a forward direction only.

FIG. 1b illustrates how the foam layer 106 is deformed when the cover 107 of the device is pressed against the transducer. As depicted in FIG. 1b a foam portion 108 of the foam layer 106 falls over the edge of the front frame whereby the distance between the foam portion 108 and the suspension member is significantly reduced. This reduced distance limits the maximum stroke of the piston accordingly. Moreover, a misalignment or displacement of the foam layer 106 relative to the front frame will cause even further acoustic disturbances in that the foam portion 108 will only be present along portions of the suspension member.

The present invention solves the above-mentioned problems.

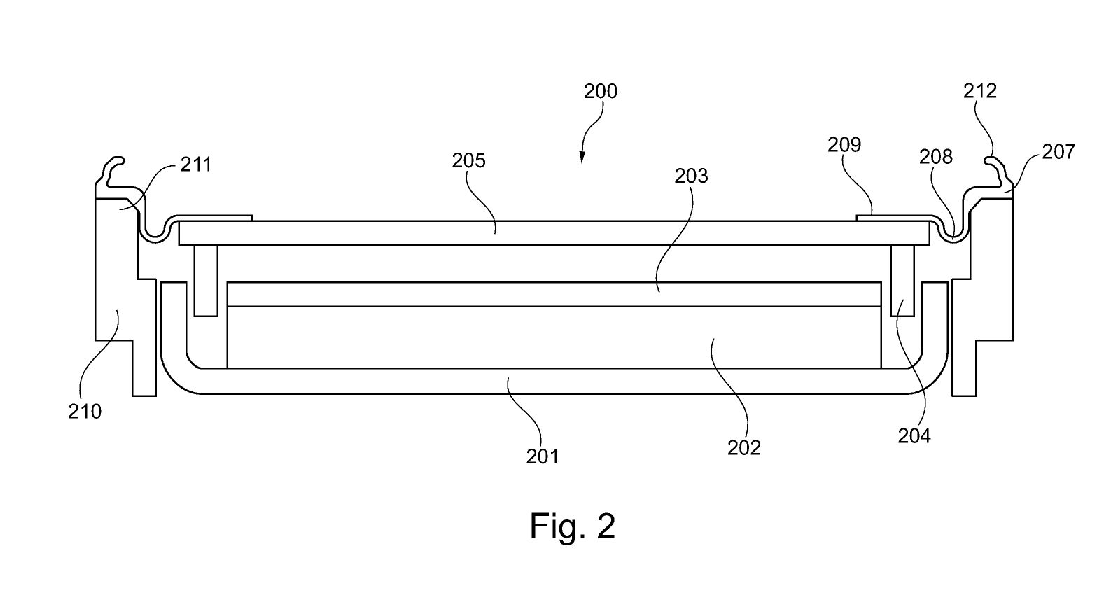

FIG. 2 shows a cross-sectional view of a miniature transducer 200 comprising a magnetic system comprising a permanent magnet 202 and inner 203 and outer pole pieces 201. The piston structure 205 is suspended in a suspension member comprising an attachment region 207, a piston region 209 and a flexible member 208 connecting the two. A voice coil 204 is attached to the piston structure 205, the latter being a mica sheet or a similar thin, stiff and light weight material.

The overall shape of the miniature transducer depicted in FIG. 2 may in principle be arbitrary including rectangular, circular and elliptical shapes. The individual dimensions (length, width or diameter) of the transducers are typically in the range of 8-20 mm. The height of a typical transducer is normally in the range 2-5 mm. However, it should be noted that the dimensions of miniature transducers may vary from these ranges. The present invention is thus not limited to transducers having dimensions strictly falling within these ranges.

Transducers of the kind depicted in FIG. 2 find their primary use as high efficient miniature loudspeakers in cell phones, tablets, game consoles, laptops etc. They are typically sandwiched between a PCB and an inner surface portion of a cover of a cell phone, tablet, game console, laptop etc.

As previously mentioned the suspension member comprises an attachment region 207, a piston region 209 and a flexible member 208 connecting the two. The attachment region 207 fixates the suspension member to a top portion 211 of frame portion 210 of the transducer typically using a glue or any other adhesive.

Preferably, the elastomeric material forming the suspension member has a hardness of Shore 40-80. The thicknesses of the attachment region 207, the piston region 209 and the flexible member 208 connecting the two typically fall within the range 0.07-0.2 mm.

The piston region 209 is attached to the piston structure 205 using an adhesive-based process, such as gluing.

The suspension member shown in FIG. 2 further comprises tolerance compensation means 212 for compensating for manufacturing and/or assembling tolerances. In particular, assembling tolerances may influence the available space at the intended position of a transducer within for example compact cell phones. Thus, even in cases where transducers are configured as SMDs and thus mounted directly on PCBs, the distance to an inner surface of a cover may vary from device to device.

The varying distance between PCB and cover is compensated for by the flexible tolerance compensation means 212.

Preferably, the tolerance compensation means 212, the attachment region 207, the piston region 209 and the flexible member 208 connecting the two are integrated in a one-piece component made of an elastomeric material, such as silicone. It is an advantage that silicone is suitable for mass production processes, such as injection moulding processes.

The flexible member 208 allows that the piston structure 205 and the voice coil 204 attached thereto can move essentially freely when a drive current is applied to the voice coil 204. As mentioned above the piston structure may be constituted by a thin sheet of mica, or a similar thin sheet material.

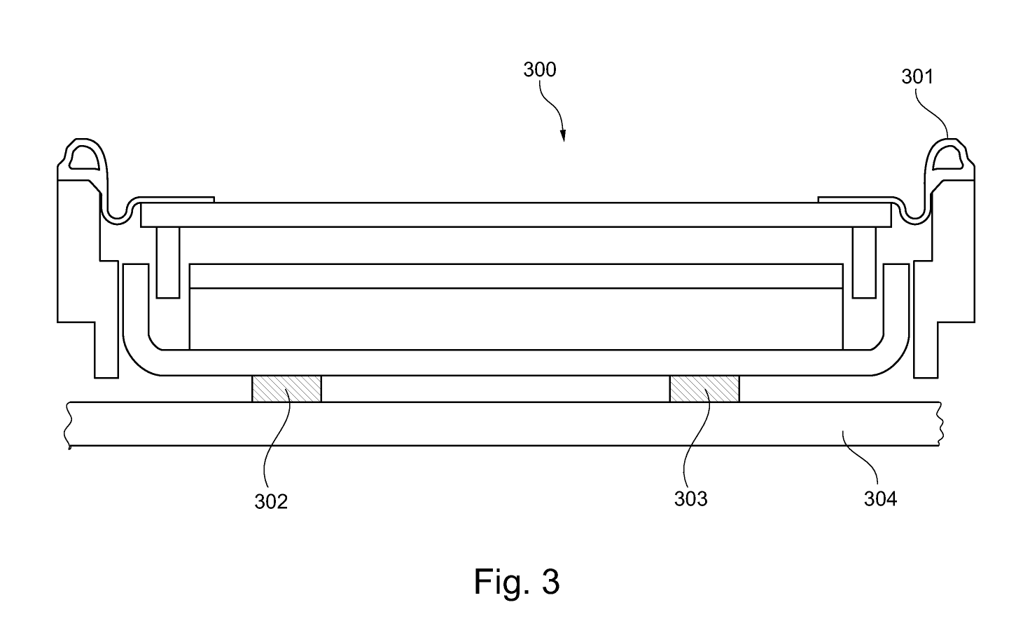

FIG. 3 shows a cross-section view of a miniature transducer 300 of the same type as shown in FIG. 2. Compared to the transducer shown in FIG. 2 the shape of the tolerance compensation means 301 has been changed to a more robust shape. In a first embodiment the tolerance compensation means 301 shown in FIG. 3 comprises a hollow core region and thereby forms a relatively soft structure. In a second embodiment the tolerance compensation means 301 may be a solid structure forming a relatively hard structure. Both embodiments may be combined with additional tolerance compensation means 302, 303 being arranged between the transducer and a cover 304 of the device housing the transducer.

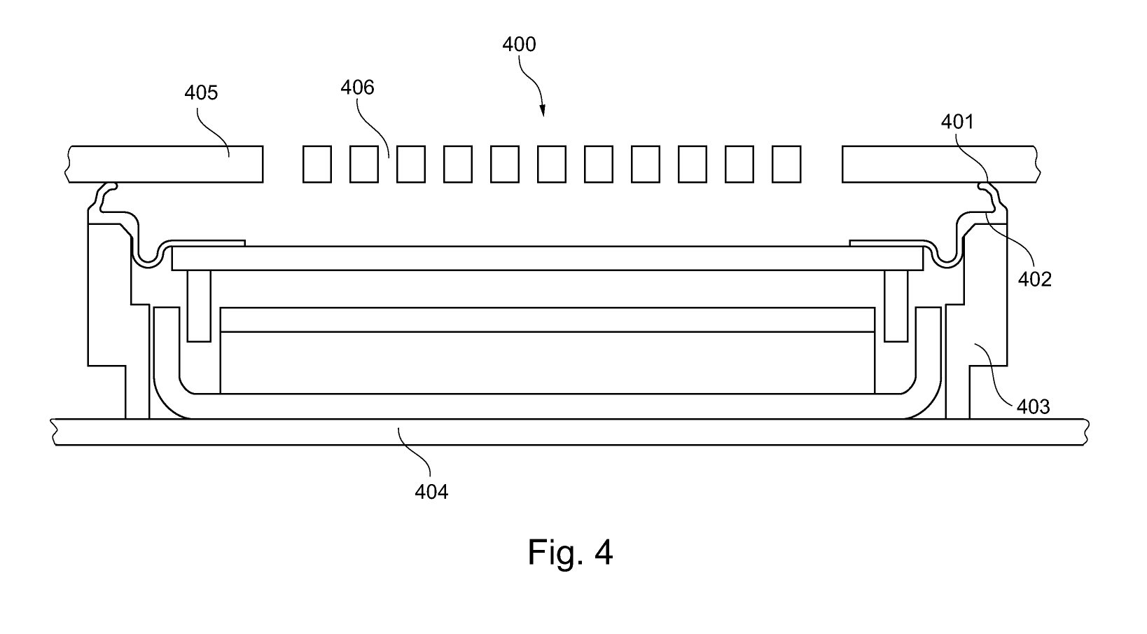

FIG. 4 shows a cross-sectional view of a miniature transducer 400 of the same type as shown in FIGS. 2 and 3. The transducer shown in FIG. 4 applies a silicone-based suspension member comprising integrated tolerance compensation means 401. The transducer shown in FIG. 4 is sandwiched between a PCB 404 and a cover 405 to which the tolerance compensation means 401 abuts. By abutting the cover 405 an acoustical seal between a front chamber and a back chamber is established.

1. A suspension member for suspending a moveable piston structure of a transducer, the suspension member comprising tolerance compensation means comprising an elastomeric material, said tolerance compensation means being formed as a structure extending in a direction so as to form an acoustical seal between a first chamber and a second chamber.

2. A suspension member according to claim 1, wherein the suspension member and the tolerance compensation means form a one-piece structure.

3. A suspension member according to claim 1, wherein the first and second chambers comprise a front chamber and a back chamber, respectively.

4. A suspension member according to claim 1, further comprising an attachment region comprising an elastomeric material, wherein at least part of the attachment region is shaped in a manner so as to be able to attach to a fixed portion of the transducer.

5. A suspension member according to claim 4, further comprising a piston region adapted to be attached to the moveable piston structure.

6. A suspension member according to claim 5, further comprising a flexible member connecting the attachment region and the piston region.

7. A suspension member according to claim 6, wherein the tolerance compensation means, attachment region, the piston region and the flexible member form an integrated one-piece structure.

8. A suspension member according to claim 6, wherein the tolerance compensation means, attachment region, the piston region and the flexible member form an integrated silicone one-piece structure.

9. A diaphragm comprising a suspension member according to claim 1, said diaphragm further comprising a moveable piston structure attached to a piston region of said suspension member.

10. A transducer comprising a diaphragm according to claim 9, said transducer further comprising a voice coil attached to a moveable piston structure, and drive means for moving the diaphragm in response to incoming electrical signals.

11. A portable communication or gaming device comprising a transducer according to claim 10.
